(19) United States
(12) Patent Application Publication
(10) Pub. No.: US 2013/0221650 A1
(43) Pub. Date: Aug. 29, 2013

(54) MUD-FLAPS FOR USE ON CAB AND CHASIS

(71) Applicants: Nancy Wiltshire, Colton, CA (US); Mokey David Wiltshire, Colton, CA (US)

(72) Inventors: Nancy Wiltshire, Colton, CA (US); Mokey David Wiltshire, Colton, CA (US)

(21) Appl. No.: 13/409,062

(22) Filed: Feb. 29, 2012

(51) Int. Cl. B62D 25/18

(52) U.S. Cl. 280/847

(57) ABSTRACT

This is directed to systems, processes, machines, and other means that produce portable mud flaps for trucks. The invention can allow a user to easily install and remove truck mud flaps.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY REFERNCE OF MATERIAL SUBMITTED ON A COMPACT DISC

Not Applicable

### FIELD OF THE INVENTION

This invention relates to mud flaps that can be used on a truck.

### BACKGROUND OF THE INVENTION

Mud-flaps have existed almost as long as automobiles. In typical use they are fixed to the chassis of a truck, and they cannot be removed or adjusted. On trucks, two standard sizes of mud-flaps exist: 32 inches in width and 42 inches in width. Prior to the disclosed invention there was no method for making a mud-flap apparatus that was portable, could accommodate both sizes of mud-flap, and that had electrical lights to improve safety and visibility.

### BACKGROUND ART

The Conner U.S. Pat. No. 3,877,722 teaches a portable mud flap for use on a truck. However, it does not teach a mud flap with electrical lights and it is limited to either a 32 inch or 42 inch mud-flap, the present invention accommodates either.

### BRIEF SUMMARY OF THE INVENTION

Methods, systems, and other means are provided for mud flaps on the back of a truck. In accordance with some embodiments, the mud flap device comprises a center bar mechanically coupled to two side bars, the side bars are each mechanically coupled to a flap bar. Notably, the two side bars can be adjusted with the flap bars to accommodate both 32 inch and 42 inch mud-flaps. The flap bars contain mud-flaps and lights.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1: is a perspective view of the invention.

FIG. 2: is a perspective view of the invention.

FIG. 3: is a detail perspective view of the invention.

FIG. 4: is an exploded view of the invention.

FIG. 5: is a forward perspective view of the frame bracket only.

FIG. 6: is a rear perspective view of the frame bracket only.

FIG. 7: is a forward perspective view of the alternate frame bracket only.

FIG. 8: is a rear perspective view of the alternate frame bracket only.

FIG. 9: is a section detail view along line 9-9 in FIG. 3.

FIG. 10: is a section detail view along line 10-10 in FIG. 2.

FIG. 11: is a perspective view illustrating the rolled-up configuration.

FIG. 12: is a side view of the invention shown encased within the carrying bag.

### DETAILED DESCRIPTION OF THE INVENTION

Embodiments of the present invention overcome many of the obstacles associated with conventional mud-flaps on a cab and chassis, and now will be described more fully hereinafter with reference to the accompanying drawings that show some, but not all embodiments of the claimed inventions. Indeed, the invention may be embodied in many different forms and should not be construed as limited to the embodiments set forth herein. Rather, these embodiments are provided so that this disclosure will satisfy applicable legal requirements. Like numbers refer to like elements throughout.

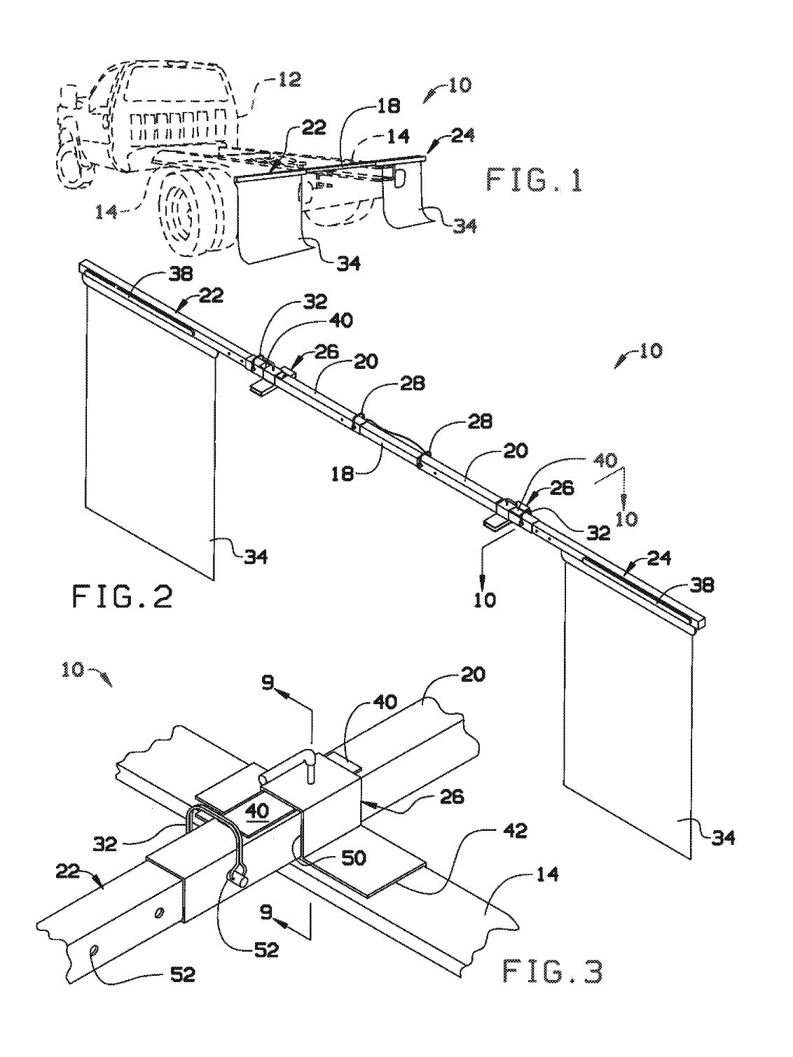

FIG. 1 shows portable mud flap 10 in use. Truck 12 comprise truck frame 14 which can be mechanically coupled to center bracket 18 as shown below. Center bracket 18 can be mechanically coupled to a left side bracket 20 and a right side bracket 20. Left side bracket 20 is mechanically coupled to left flap bracket 22 as shown in FIG. 2 and FIG. 4. The right side bracket 20 is mechanically coupled to right flap bracket 24 as shown in FIG. 2 and FIG. 4. Left flap bracket 22 is mechanically coupled to a first mud-flap 34 and right flap bracket 24 is mechanically coupled to a second mud-flap 34 as indicated in FIG. 2 and FIG. 4.

FIG. 2 shows portable mud flap 10 without truck frame 14. As noted above portable mud-flap 10 comprises center bracket 18 which further comprises a first plurality of clip holes 52. Similarly, left side bracket 20 comprises a second plurality of clip holes 52, right side bracket 20 further comprises a third plurality of clip holes 52. Center bracket 18 is mechanically coupled to a left side bracket 20 and held in place by first center bracket clip 28 through a first clip hole 52 in left side bracket 20 through a second clip hole in center bracket 18. Similarly, a right side bracket 20 and held in place by second center bracket clip 28 though a third clip hole 52 in right side bracket 20 and a fourth clip hole 52 in center bracket 18.

The left side bracket 20 is mechanically coupled to truck frame 14 (not shown) by a first frame bracket 26 and clamp rubber padding 40 as shown in FIG. 3. Similarly, the right side bracket 20 is mechanically coupled to truck frame 14 (not shown) by a second frame bracket 26 and clamp rubber padding 40 as shown in FIG. 3.

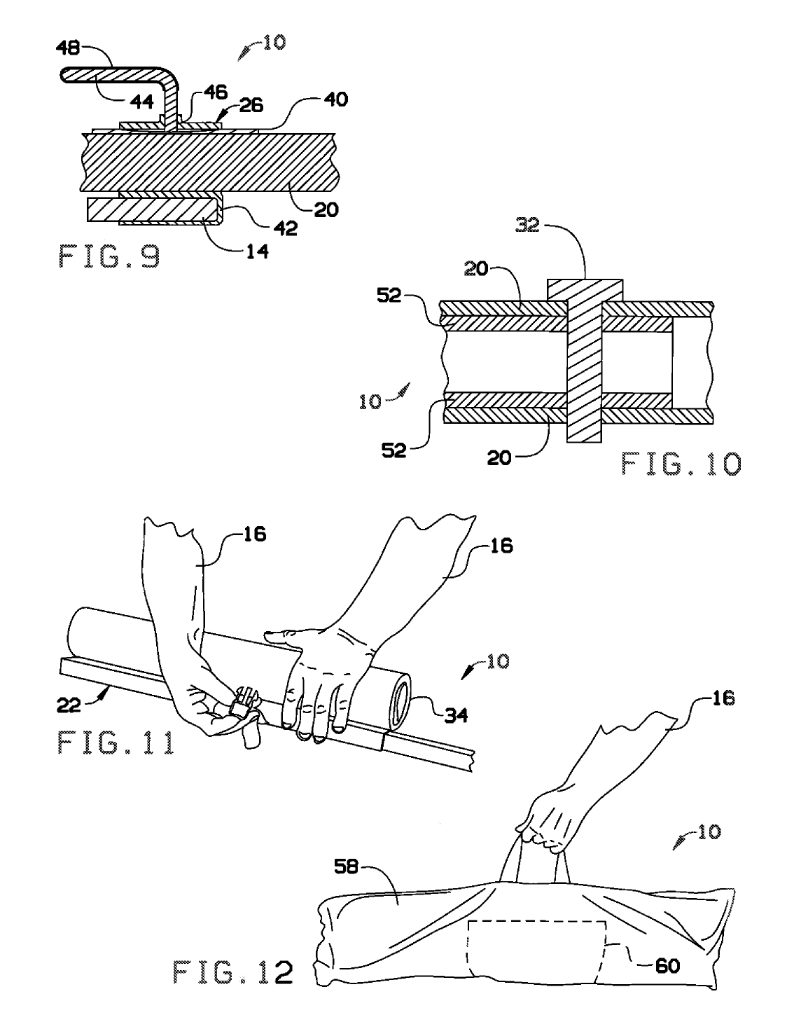

FIG. 3 shows the mechanical couple between the left side bracket 20 and truck frame 14 in more detail. Left side bracket 20 is mechanically coupled to left flap bracket 22 by inserting a first flap bracket clip 32 placed through a fifth clip hole 52 in left side bracket 20 thought a sixth clip hole in left flap bracket 22 forming a third mechanical couple. As shown, left flap bracket 22 further comprises a fourth plurality of clip holes 52 at a variety of locations to adjust the position of left flap bracket 22 to accommodate a user preference. Clamp rubber padding 40 is placed on top of left side bracket 20 and then left side frame bracket U-hook 42 is placed on top of clamp rubber padding 40 such that frame bracket slot 50 is aligned as shown in FIG. 9.

Similarly, right side bracket 20 is mechanically coupled to right flap bracket 24 by a second flap bracket clip 32 placed through a seventh clip hole 52 in right side bracket 20 through an eighth clip hole in right flap bracket 24 forming a fifth mechanical couple. Right flap bracket further comprises a fifth plurality of clip holes 52 drilled into right flap bracket 24 (not shown) at a plurality of locations to adjust the position of right flap bracket 24 to accommodate a user preference. Clamp rubber padding 40 is placed on top of right side bracket 20 and then right side frame bracket U-hook 42 is placed on top of clamp rubber padding 40 such that frame bracket slot 50 is aligned as shown in FIG. 9.

FIG. 4 shows an exploded view of portable mud-flap 10 in more detail. Center bracket 18 comprises a plurality of clamp holes 52. Similarly, left side bracket 20 and right side bracket 20 comprise a plurality of clip holes 52. A user can mechanically couple center bracket 18 to left side bracket 20 by inserting a first center bracket clip 28 through clip hole 52 in left side bracket 20, though clip hole 52 in center bracket 18 creating a first mechanical couple. Center bracket clip lanyard 30 mechanically couples a first center bracket clip 28 to a second center bracket clip 28. In a similar manner, a user can mechanically couple center bracket 18 to right side bracket 20 by inserting a second center bracket clip 28 through clip hole 52 in right side bracket 20, though clip hole 52 in center bracket 18 creating a second mechanical couple.

Right side bracket 20 is mechanically coupled to right flap bracket 24 by aligning right side bracket 20 with right flap bracket 24 such that a user determined clip hole 52 in right flap bracket 24 aligns with a clip hole 52 in right side bracket 20 and then the user inserts a first flap bracket clip 32 through right side bracket 20 through right flap bracket 24 completing the fifth mechanical couple. Similarly, left side bracket 20 is mechanically coupled to left flap bracket 22 by aligning left side bracket 20 with left flap bracket 22 such that a user determined clip hole 52 in left flap bracket 22 aligns with a clip hole 52 in left side bracket 20 and then the user inserts a flap bracket clip 32 through left side bracket 20 through left flap bracket 22 completing the fourth mechanical couple.

Right flap bracket 24 comprises a plurality of clip holes 52 so that right flap bracket 24 can be aligned to accommodate user preference. Right flap bracket 24 further comprises a first rear light 38 and a first mud-flap 34. First rear light 38 is mechanically coupled to right flap bracket 24 and electrically coupled to truck 12 (not shown), such that first rear light 38 can accomplish the same function as a truck brake light. Similarly, left flap bracket 22 comprises a plurality of clip holes 52 so that left flap bracket 22 can be aligned to accommodate user preference. Left flap bracket 22 further comprises second rear light 38 and a second mud-flap 34, which has the same use and functionality noted above. The second mud-flap is mechanically coupled to left flap bracket 22 with a sixth mechanical couple.

FIG. 5 shows frame bracket 26 in more detail as it appears on the left side. Left side frame bracket 26 comprises left side frame bracket U-hook 42 mechanically coupled to left frame bracket slot 50. A user can mechanically couple left side bracket 20 to truck frame 14 (not shown) as shown in FIG. 9.

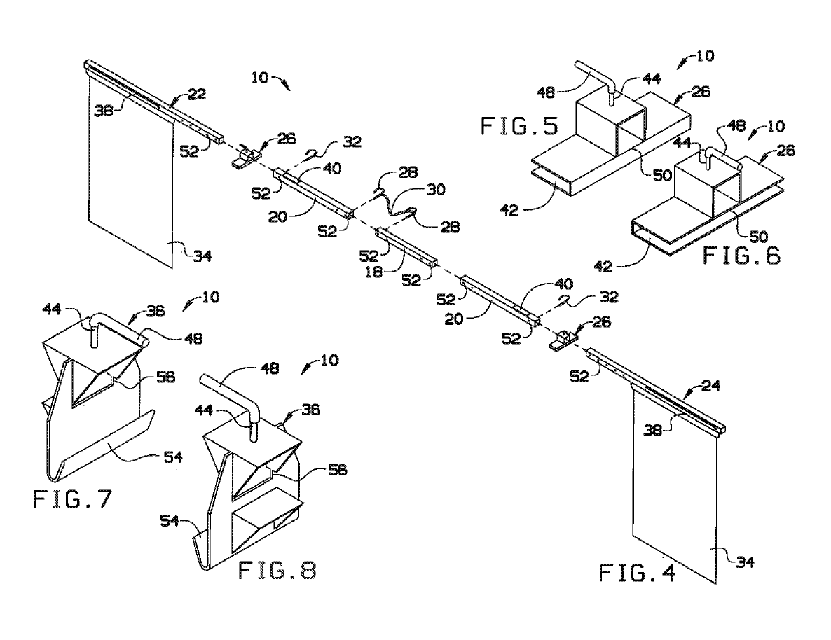

FIG. 6 shows frame bracket 26 in more detail as it appears on the right side. Right side frame bracket 26 comprises right side frame bracket U-hook 42 mechanically coupled to right side frame bracket slot 50. A user can mechanically couple right side bracket 20 to truck frame 14 (not shown) as shown in FIG. 9.

FIG. 7 shows alternate frame bracket 36 in more detail as it appears on the left side. Left side alternate frame bracket 36 comprises left side alternate bracket hook 54 mechanically coupled to left side alternate bracket slot 56. A user can mechanically couple alternate frame bracket 36 to truck frame 14 (not shown) in a manner similar to the one shown in FIG. 9.

FIG. 8 shows alternate frame bracket 36 in more detail as it appears on the right side. Right side alternate frame bracket 36 comprises right side alternate bracket hook 54 mechanically coupled to right side alternate bracket slot 56. A user can mechanically couple alternate frame bracket 36 to truck frame 14 (not shown) in a manner similar to the one shown in FIG. 9.

FIG. 9 shows a section view of frame bracket 26. Side bracket 20 is mechanically coupled to truck frame 14 by frame bracket U-hook 42. As noted above a user can insert side bracket 20 through frame bracket U-hook 42. After that a user can mechanically couple side bracket 20 to frame bracket U-hook 42 by inserting clamp rod 44 through frame bracket U-hook 42 into left side bracket 20 and completing the mechanical couple with rod handle 48.

FIG. 10 shows flap bracket clip 32 in use from a perspective view. A user can mechanically couple side bracket 20 to center bracket 18 by inserting flap bracket clip 32 through clip hole 52. Similarly, a user can use this technique to mechanically couple side bracket 20 to right flap bracket 24 or to mechanically couple side bracket 20 to left flap bracket 22.

FIG. 11 shows user 16 preparing portable mud-flap 10 for storage. User 16 can collapse portable mud-flap 10 into a singular bar with a flap by decoupling left flap bracket 22 from left side bracket 20 by further removing clamp rod 44 from clip hole 52. At this point, mud flap 34 can be rolled into a portable side and held in place with a snap, clip or other device depending on user preference.

FIG. 12 shows the device completely collapsed and prepared for portable storage. User 16 has placed invention 12, which has been collapsed as explained above, into carrying bag 58. Carrying bag 58 may have logo 60 attached as necessary.

That which is claimed:

1. A portable mud flap for use on a chassis, comprising,
A center bracket mechanically coupled to a left side bracket with a first mechanical couple and a right side bracket with a second mechanical couple;
where the left side bracket is mechanically coupled to a left flap bracket with a third mechanical couple; where the left flap bracket is further mechanically coupled to a first mud-flap with a fourth mechanical couple;
where the right side bracket is mechanically coupled to a right flap bracket with a fifth mechanical couple; where the right flap bracket is further mechanically coupled to a second mud-flap with a sixth mechanical couple.

2. The portable mud flap for use on a chassis of claim 1, further comprising,
the center bracket further comprises a first plurality of clip holes; the left side bracket further comprises a second plurality of clip holes; the right side bracket further comprises a third plurality of clip holes; the left flap bracket further comprises a fourth plurality of clip holes; the right flap bracket further comprises a fifth plurality of clip holes;
the first mechanical couple further comprises a user inserting a first center bracket clip through a first clip hole in the left side bracket through a second clip hole in the center bracket;
the second mechanical couple further comprises the user inserting a second center bracket clip through a third clip hole in the right side bracket through a fourth clip hole in the center bracket;
the third mechanical couple further comprises the user inserting a first flap bracket clip through a fifth clip hole in the left side bracket through a sixth clip hole in the left flap bracket;
the fifth mechanical couple further comprises the user inserting a second flap bracket clip through a seventh clip hole in the right side bracket through an eighth clip hole in the right flap bracket.

3. The portable mud flap for use on a chassis of claim 1, further comprising,
a first rear light mechanically coupled to the right flap bracket;
where the first rear light is electrically coupled to a truck;
a second rear light mechanically coupled to the left flap bracket;
where the second rear light is electrically coupled to the truck;

4. The portable mud flap for use on a chassis of claim 1, further comprising,
the left side bracket is mechanically coupled to a truck frame with a left side frame bracket;
where the left side frame bracket comprises a left side frame bracket U-hook mechanically coupled to a left frame bracket slot;
the right side bracket is mechanically coupled to the truck frame with a right side frame bracket;
where the right side frame bracket comprises a right side frame bracket U-hook mechanically coupled to a right side frame bracket slot.

5. The portable mud flap for use on a chassis of claim 1, further comprising,
the left side bracket is mechanically coupled to a truck frame with a left side alternate frame bracket;
where the left side alternate frame bracket comprises a left side alternate bracket hook mechanically coupled to a left side alternate bracket slot;
the right side bracket is mechanically coupled to the truck frame with a right side alternate frame bracket;
where the right side alternate frame bracket comprises a right side alternate bracket hook mechanically coupled to a right side alternate bracket slot.
